(19) United States
(12) Patent Application Publication
(10) Pub. No.: US 2016/0372006 A1
(43) Pub. Date: Dec. 22, 2016

(54) METHODS FOR WELDING TRAINING

(71) Applicant: Joachim Berkmanns, Oakville (CA)

(72) Inventor: Joachim Berkmanns, Oakville (CA)

(21) Appl. No.: 14/746,201

(22) Filed: Jun. 22, 2015

(51) Int. Cl. G09B 19/24; B23K 9/02

(52) U.S. Cl. CPC G09B 19/24; B23K 9/02

(57) ABSTRACT

A method and apparatus for training a welder to avoid welding either too fast or too slow is disclosed. The welder learns to weld more efficiently by the steps of a) forming a welding sample, wherein the welding sample has one or more predetermined spots (marks or markings) along its length; b) starting an application on a computer; c) starting a welding torch; d) simultaneously to step c) communicating a spoken command to the application on the computer; e) beginning welding on the welding sample, thereby creating a weld; f) communicating a spoken command to the application on the computer when the weld has reached a predetermined spot along the welding sample; and g) immediately receiving a communication from the application on the computer in response to the spoken command of step f).

### BACKGROUND OF THE INVENTION

During gas metal arc welding (G AW) operations, the welder attempts to produce a weld as specified in a drawing or welding procedure sheet (WPS). A weld performed to specification will have enough strength to carry the intended load.

One of the most common and costly problems in welding is “overwelding”. Overwelding means the situation where too much filler wire is deposited per unit length because the welder welds too slowly for a given wire speed. By welding too slowly, the welder not only wastes time but also deposits more wire material than is necessary to form a proper weld. So for example, a fillet weld with a 3/16 of an inch leg size is specified but the welder produces a one quarter inch fillet, then there is an increase of 78% in the wire used. Overwelding will also cause those applications where the weld joints need to be cleaned after the welding operation to need excessive grinding time and use of abrasives.

The problem with overwelding is based on a desire to form a proper weld and be on the safe side as far as weld strength is concerned. However, slower welding and a greater use of welding wire results in significant amounts of money wasted in labor and material.

Gauges are typically used to measure a weld after its completion. However by then, it is too late to determine if overwelding has occurred and adjust the weld accordingly. While this may be beneficial in terms of the welder adjusting speed on the next weld, this is inefficient because the feed back is not instantaneous. Virtual weld trainers and weld simulators try to address this problem but they are expensive. Further there is always the transition from the virtual training environment to the real welding in industrial applications that must be taken into consideration as well.

As such, it can be seen that an inexpensive training solution that is widely accessible and applicable to real time welding is still needed.

This solution is provided by a training application which can provide the welder instantaneous feedback as to whether their welding is too fast or too slow. The training application is activated by a wired or wireless (Bluetooth) connection between a computer preferably portable such as a smartphone or tablet and a microphone on or in close proximity to the welder. Feedback is then given to the welder via a headset or speaker worn by the welder or incorporated in the welding helmet or protective gear.

### SUMMARY OF THE INVENTION

In a first embodiment of the invention, there is disclosed a method for training a welder to weld more efficiently comprising the steps of:

a) forming a welding sample, wherein the welding sample has one or more predetermined spots (marks, markings) along its length;
b) starting an application on a computer;
c) starting a welding torch;
d) simultaneously to step (c) communicating a spoken command to the application on the computer:
e) beginning welding on the welding sample, thereby creating a weld;
f) communicating a spoken command to the application on the computer when the weld has reached a predetermined spot (mark, marking) along the welding sample; and
g) immediately receiving a communication from the application on the computer in response to the spoken command of step f).

The communicating comprises speaking a command to the application on the computer and receiving feedback from the application on the computer.

The welding sample is typically a joint between two pieces of metal that will have one or more predetermined spots which are equidistant from each other. These equidistant predetermined spots are put on the welding sample in anticipation of the training.

The computer employed may be any traditional computer such as a desktop or laptop but may preferably be a smartphone.

A variety of welding techniques and accompanying torches can be employed in the training operation for example those selected from the group consisting of arc welding, tungsten inert gas welding, plasma arc welding, and shielded metal arc welding.

The spoken commands of steps d) and f) are made into a microphone. The microphone is mounted on welding apparel selected from the group consisting of a welding helmet, goggles, gloves, vest and jacket. The microphone may be physically separate from the welder as well by being in close proximity through means of holding the microphone.

The microphone is connected to the computer. This connection may be by a wired connection or by a wireless connection. In the event the connection is a wireless connection, the connection may be through a Bluetooth connection.

The application comprises means to interpret the spoken command.

The spoken command to the application on the computer will start a timing mechanism and the spoken command of step f) will stop the timing mechanism, reset the timing mechanism and start the timing mechanism over again from zero time.

The welder further continues the weld of step e) towards a second predetermined spot along the welding sample.

The communication from the application on the computer will be to a headset. The communication from the application on the computer will inform the welder of the welding speed. This communication will alert the welder undergoing the training as to whether the weld between two points on the welding sample has been completed too slowly, too fast or good. Depending upon the feedback from the application, the welder will adjust the welding speed: As each mark is passed the welder receives feedback from the application as to the speed of the welding.

The headset can be any type of headset where the speakers are placed on the ear or are inserted into the ear. Alternatively the feedback from this weld application to the welder could also be given via a speaker incorporated into the welding helmet or attached to the welding gear or visually, for example using light indicators in the helmet.

In a different embodiment of the invention, there is disclosed a welding training apparatus comprising a computer, a welding torch, a welding sample, and a welding apparel, wherein the welding apparel contains a microphone in communication with the computer.

The welding apparel is selected from the group consisting of a we/ding helmet, goggles, gloves, vest and jacket.

The spoken command of steps d) and f) are made into a microphone. The microphone is mounted on welding apparel selected from the group consisting of a welding helmet, goggles, gloves, vest and jacket. The microphone may be physically separate from the welder as well by being in close proximity through means of holding the microphone.

The microphone is connected to the computer and this connection may be wired or wireless connections. In the event of a wireless connection, the connection may be through a Bluetooth connection.

The application comprises means to interpret the spoken command.

The welding sample is typically a joint between two pieces of metal that will have one or more predetermined spots are equidistant from each other: These equidistant predetermined spots are put on the welding sample in anticipation of the training.

### BRIEF DESCRIPTION OF THE DRAWINGS

FIG. 1 is a schematic rendering of a series of tacks along a welding sample which the welder guides a welding torch in conjunction with the training application.

FIG. 2 is a schematic rendering of a series of tacks along a welding sample showing the progression of the weld as used with the training application.

FIGS. 3A, 3B, 3C and 3D represent certain joint geometries that may be programmed into the training application.

### DETAILED DESCRIPTION OF THE INVENTION

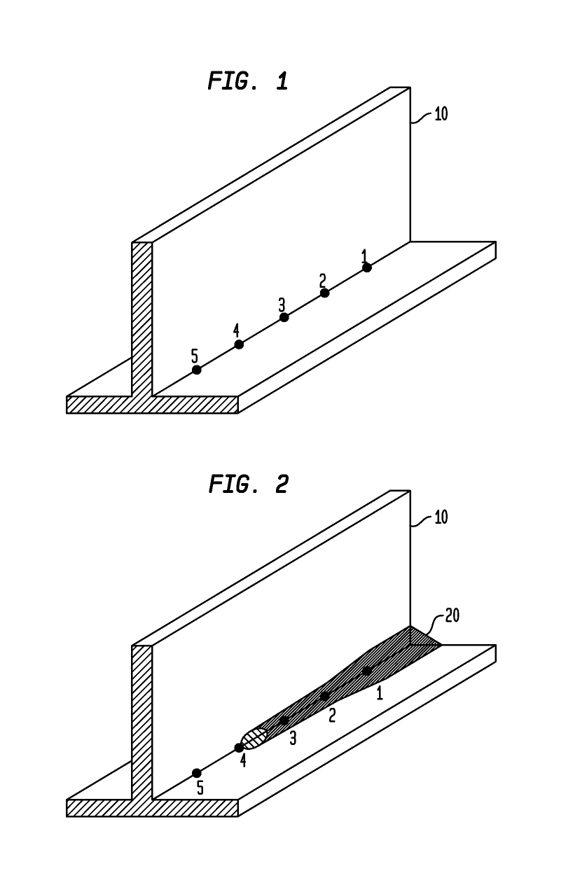

For training purposes, as shown in FIG. 1, the welder tacks up some fillet welds or other joint geometries and puts down marks 1, 2, 3, 4 and 5 an equal distance apart (i.e., every one inch) on said welding sample 10. The training application can then be opened up on a computer such as a smartphone and a series of parameters can be entered using the touch screen of the smartphone.

These parameters can include the distance between the marks, the joint geometry, for example, fillet with required leg size and the wire diameter and wire feed rate that is going to be employed for the training operation.

Based on the input the application will calculate the speed at which the welding torch will need to be moved along the weld path in order to deposit the correct amount of filler wire per unit of weld length and the welding training can begin.

The application essentially calculates the speed at which the torch needs to be moved in order to deposit enough wire to fill any gaps and in addition create the desired root or top reinforcement. Therefore, the training application is preprogrammed with a library of commonly used joint geometries. Once a joint geometry is picked it will ask the welder to input all data necessary to calculate the gap volume and volume of the reinforcement between two marks. Finally, the training application will ask for the diameter of the welding wire and the intended wire feed speed. Dividing the total volume of gap and reinforcement by the wire volume deposited per unit time will allow the training application to calculate the time needed from one mark to the next.

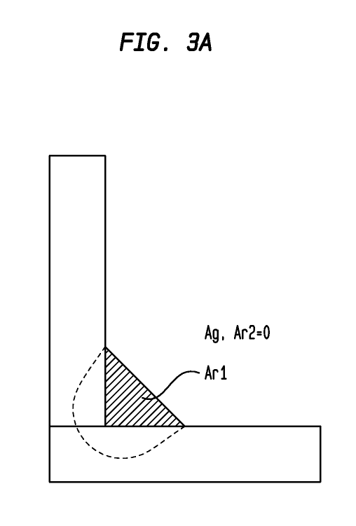

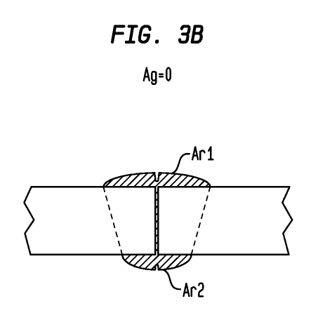

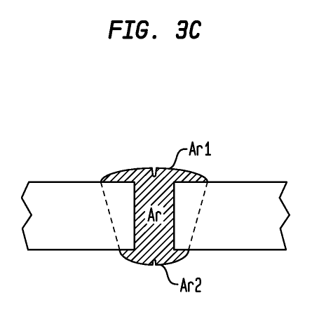

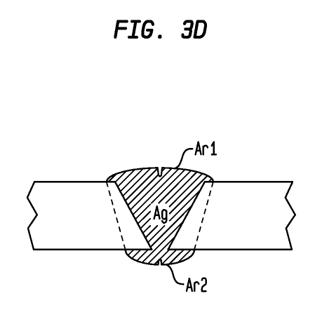

FIGS. 3A, 3B, 3C and 3D show four joint geometries that may be employed as part of the training application. These are representative joint geometries however the training application is not limited solely to these. These are commonly used geometries that are often welded in a single pass. In FIGS. 3A, 3B, 3C and 3D, the capital letter “A” identifies a portion of the cross section area of the weld that needs to be filled with filler wire. The index “g” indentifies gap area, “r1” the overbead or top reinforcement and “r2” the root reinforcement.

In the case of the fillet weld in FIG. 3A the connection is made by depositing the correct amount of filler wire to fill up the triangular shaped area. Ag and Art are both zero.

In the case of the butt joint in FIG. 3B where Ag is zero, filler material is needed to create the convex overbead and root reinforcements, which can be described for example as circle segments.

If there is a gap between the square edged Material as shown in FIG. 3C or if the edge has been prepared in the shape of a V in FIG. 3D then the gap volumes as well as the concave overbead and root areas have to be filled with filler wire.

The dashed lines within each of the four joint geometries of FIGS. 3A, 3B, 3C and 3D represent the fusion line of the completed weld seam.

All these areas can be described with simple mathematical formulas (I) and (H) below and when multiplied with the distance between two marks determine the volume of filler material that needs to be deposited. Dividing this volume by the volume of wire that is fed into the welding process per unit time, calculated by multiplying the wire cross section with the wire feed speed, results in the speed at which the welding torch has to move.

(I) The total gap and reinforcement volume=(Ag+Ar1+Ar2)*the distance between marks.

(II) The time to reach the next mark=(Ag+Ar1+Ar2)*the distance between marks/(wire cross section*wire feed speed)

Additionally, instead of relying on the training application to calculate the speed at which the torch has to be moved based on the calculations described above, the appropriate speed may be determined by a weld trainer, welding instructor or may be already given on the weld procedures. In this case, the weld target speed can simply be put into the training application and the training application will then time the welder against this desired target speed.

The welding torch, type and source of shielding gas, welding wire and related feeding and power source equipment are all typical of what a welder employs in welding operations so there is no need for special welding equipment. The welder will ignite the torch and begin the welding operations on the welding sample 10 in FIG. 2. At the same time the welder will say “start” or another word signifying that the welding training application should begin the training application. When the molten pool 20 reaches the first mark 1, the welder says “mark” or other equivalent signifier into the microphone. The welding application having measured the time from when the welder said “start” will immediately inform the welder that the welding operation, as measured by the time it took the welder to reach the first mark was proceeding either too slowly, too fast or just right, Here, the welder was too slow in laying down the weld from the start to mark 1 and therefore the computer states “faster” upon the welder communicating that this mark was achieved. At the same time the weld training application has also started to measure the time the welder will need to progress to mark 2.

For purposes of the training application, the time necessary to achieve “just right” will be a range of time in which the welder should be moving the welding torch from one mark to the next. so that the welder does not need to “hit” a particular time for the weld to be considered good.

The training application will inform the welder at each mark of whether the welding operation is proceeding too fast or too slow and the welder can adjust the speed of the welding torch as it progresses to the next mark.

The welder can continue welding for as many marks as originally laid out on the welding sample and entered into the training application. So as noted here in FIGS. 1 and 9 five marks are laid out equidistant from each other.

As shown in FIG. 1, a welder has laid out five marks 1, 2, 3, 4 and 5 and has tacked them at exactly one inch spacing between the marks.

FIG. 2 shows the progression of the weld 20 performed per the training application, In this example, the welder began by stating “start” into the microphone which transmitted the signal to the welding application present on the computer. The welding application had already been configured with the various parameters necessary to measure the welding operation properly, namely distance between marks, the joint geometry, leg size and the wire diameter and wire feed rate. When the welder reached the first mark 1, “mark” was stated into the microphone and the welding training application immediately stated “faster” which means that the welder was too slow directing the welding torch from the starting mark to the first mark and consequently overwelded the metal,

Now without losing eye contact with the welding sample, the welder continues the welding of the weld 20 at slightly increase speed from the first mark to the second mark 2 at which point “mark” is again stated and the welding training application immediately responds to the headset in the welding helmet “faster” which again indicates that the welder was still too slow between the first mark 1 and the second mark 2. When the tip of the molten pool or weld 20 touches the third mark 3 the welder says “mark” again and the welding training application immediately responds to the welder's helmet “good” and the welder knows that the proper welding speed was employed for that inch on the welding sample.

The example shown in FIG. 2 only has the welder welding through to marks 1, 2 and 3 on the welding sample. The application though may have any number of marks input into it for training purposes so that the welder could have continued this training example through marks 4 and 5 and any number of marks beyond mark 5 that are not shown in FIG. 2.

The equipment employed in operating the welding training includes a computer such as a smartphone, a welding apparatus, a welding torch and welding apparel wherein the welding apparel contains a microphone and headset in communication with the computer.

The smartphone can be any phone capable of running the application training program and capable of wired or wireless communication with the microphone and headset present on or in the vicinity of the welder. Smartphones such as the iPhone 6 from Apple and the Samsung Galaxy would be useful in performing the training application. A headset can be any type of headset where the speakers are sitting on the ear or are inserted into the ear. Alternatively the feedback from this weld application to the welder could also be given via a speaker incorporated in the welding helmet or attached to the welding gear or visually, for example using light indicators in the helmet

For purposes of the present invention, microphone is defined as including any type of suitable receiver which can produce an electrical signal from air pressure variations. The microphone may be one microphone or more than one microphone depending upon the type of welding operation and need for redundancy.

The spoken command, “start”, “mark”, etc. is made by the welder in the vicinity of a microphone. The microphone may be incorporated into sections of the welder's clothing.

For example, the microphone may be incorporated into a welder's welding apparel which is selected from the group consisting of a welding helmet, goggles, gloves, vest and jackets including other protective gear typically worn by a welder during welding operations. The microphone may also be physically separate from the welder but in close proximity to the welder. Preferably, the spoken command is made into a microphone that is present in a welding helmet.

The microphone is connected to the smartphone and this connection can be selected from the group consisting of either a wired connection or a wireless connection, The wireless connection can be a Bluetooth connection.

In other embodiments of the invention, the training too could be employed in production operations where the parts could be etched or ink marked by a laser or plasma cutter as the parts are being prepared for welding, So for example, the position of a reinforcement bracket that is to be welded onto the side of a pressure vessel can be ink marked in a previous production step. The ink markings can be equidistant and the welder can then use the training application in order to control and improve the motion of the weld around the path.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

1. A method for training a welder to weld more efficiently comprising the steps of:
a) forming a welding sample, wherein the welding sample has one or more predetermined spots along its length;
b) starting an application on a computer;
starting a welding torch;
d) communicating a spoken command to the application on the computer;
e) beginning welding on the welding sample, thereby creating a weld;
communicating a spoken command to the application on the computer when the weld has reached a predetermined spot along the welding sample; and
g) receiving a communication from the application on the computer in response to the spoken command of step f).

2. The method as claimed in claim 1 wherein the welding sample is a joint between two pieces of metal.

3. The method as claimed in claim 1 wherein the one or more predetermined spots are equidistant from each other.

4. The method as claimed in claim 1 wherein the computer is a smartphone.

5. The method as claimed in claim 1 wherein the welding torch is used in a welding operation selected from the group consisting of arc welding, tungsten inert gas welding, plasma arc welding, and shielded metal arc welding,

6. The method as claimed in claim 1 wherein said communicating comprises speaking a command to the application on the computer and receiving feedback from the application on the computer.

7. The method as claimed in claim 1 wherein the spoken command of steps d) and f) are made into a microphone.

8. The method as claimed in claim 7 wherein the microphone is mounted on welding apparel selected from the group consisting of a welding helmet, goggles, gloves, vest and jacket.

9. The method as claimed in claim 7 wherein the microphone is physically separate from a welder.

10. The method as claimed in claim 7 wherein the microphone is connected to the computer.

11. The method as claimed in claim 10 wherein the connection is selected from the group consisting of wired connections and wireless connections.

12. The method as claimed in claim 11 wherein the wireless connection is a Bluetooth connection.

13. The method as claimed in claim 1 wherein the application comprises means to interpret the spoken command.

14. The method as claimed in claim 1 wherein the spoken command to the application on the computer will start a timing mechanism.

15. The method as claimed in claim 1 wherein the spoken command of step f) will stop the timing mechanism, reset the timing mechanism and start the timing mechanism over again from zero time.

16. The method as claimed in claim 1 wherein the welder further continues the weld of step e) towards a second predetermined spot along the welding sample.

17. The method as claimed in claim 1 wherein the communication from the application on the computer will be to the microphone.

18. The method as claimed in claim 1 wherein the communication from the application on the computer will inform the welder of the welding speed.

19. The method as claimed in claim 1 wherein the welding speed is selected from the group consisting of too slow, too fast or correct.

20. The method as claimed in claim 1 wherein the welder will adjust the welding speed based upon the communication from the application on the computer.

21. The method as claimed in claim 1 wherein the training occurs during production welding operations.

22. A welding training apparatus comprising a computer, a welding torch, a welding sample, and a welding apparel, wherein the welding apparel contains a microphone in communication with the computer.

23. The welding training apparatus as claimed in claim 21 wherein the welding apparel is selected from the group consisting of a welding helmet, goggles, gloves, vest and jacket.

24. The welding training apparatus as claimed in claim 21 wherein the microphone is connected to the computer.

25. The welding training apparatus as claimed in claim 24 wherein the computer is a smartphone.

26. The welding training apparatus as claimed in claim 24 wherein the connection is selected from the group consisting of wired connections and wireless connections.

27. The welding training apparatus as claimed in claim 26 wherein the wireless connection is a Bluetooth connection.

28. The welding training apparatus as claimed in claim 22 wherein the computer further comprises means to interpret the spoken command.

29. The welding training apparatus as claimed in claim 22 wherein the welding sample is a joint between two pieces of metal.
